(19) United States
(12) Patent Application Publication
(10) Pub. No.: US 2009/0015586 A1
(43) Pub. Date: Jan. 15, 2009

(54) Method and system for modeling variable-node finite elements and application to nonmatching meshes

(75) Inventors: Seyoung Im, Daejeon (KR); Jae Hyuk Lim, Daejeon (KR); Young-Sam Cho, Daejeon (KR); Hyun-Gyu Kim, Seoul (KR)

Correspondence Address: THE NATH LAW GROUP, 112 South West Street, Alexandria, VA, 22314, US

(73) Assignee: KOREA ADVANCED INSTITUTE OF SCIENCE AND TECHNOLOGY, Daejeon (KR)

(21) Appl. No.: 12/007,245

(22) Filed: Jan. 8, 2008

(30) Foreign Application Priority Data
Jul. 9, 2007 (KR) 10-2007-0068830

(51) Int. Cl. G06T 15/30

(52) U.S. Cl. 345/423

(57) ABSTRACT

The present invention relates to a method and system for modeling non-matching finite element meshes using variable-node finite elements in the finite element method. More specifically, a method and recording medium for modeling a variable-node finite element for application to non-matching meshes using the finite element method performed via a computer and using the existing four-node linear quadrangular element, eight-node secondary quadrangular element, nine-node secondary quadrangular element, and eight-node hexahedral element, wherein the finite element analysis method includes: a first step of confirming the number of nodes added to boundary surfaces of the non-matching meshes; a second step of dividing the boundary surfaces of the non-matching meshes into partial boundary surfaces divided by means of the added nodes; a third step of dividing the non-matching meshes into partial regions based on the partial boundary surfaces divided in the second step; a fourth step of performing a point interpolation based on the nodes affecting each partial region divided in the third step; and a fifth step of integrating each of the partial regions through numerical integration.

This application claims priority to Korean Patent Application No. 10-2007-68830, filed on Jul. 9, 2007, in the Korean Intellectual Property Office, the entire contents of which are hereby incorporated by reference.

### BACKGROUND OF THE INVENTION

1. Field of the Invention

The present invention relates to new variable-node finite elements in a finite element method and their application to modeling non-matching meshes.

2. Description of the Related Art

Generally, in a field of intensively studying a structural analysis of an object such as in mechanical engineering, a finite element method (FEM), which is one of numerical analysis methods using differential equations, has widely been used. Such a finite element method is mainly applied to an analysis of strength and deformation of machine/structure, an analysis of fluid flow, an analysis of electromagnetic field, etc. To this end, a region to be analyzed is divided into small area or volume with the aid of mesh generation. The finite element mesh is basically configured of an element that is one volume and a node consisting of the element. When elements configured of the finite element mesh are adjacent to each other, they should necessarily share nodes at boundary surfaces. Such element structure is referred to as matching mesh.

One of the most difficult problems to address in the finite element method is related to non-matching meshes. In the case of a contact, a substructuring, an adaptive mesh refinement, or the like, which are various problems caused by the non-matching mesh, accuracy of solution at the boundary surfaces of the non-matching meshes is extremely decreased so that it is hard to expect a good solution. In order to overcome this problem, a two layer approach and a three layer approach using a Lagrange multiplier or a penalty function or various approach methods using a moving least-squares approximation has been proposed.

FIG. 1 is a concept view of a two layer approach method and a three layer approach method in the prior art. The two layer approach method is a method of introducing the Lagrange multiplier or the penalty function commonly used in constrained optimization in order to treat the problem of the non-matching finite element meshes that do not share the node of the element. With this method, a set of boundary condition is added to the existing finite element method so that the problem including the non-matching meshes can easily be addressed. However, it degrades the accuracy of a solution and does not satisfy the patch test, which is one of the convergence conditions of the finite element solution. In other words, it has a limitation in assuring the convergence of solution.

The three layer method is a method of introducing a frame element between the non-matching meshes in order to overcome the limitation of the problem of the two layer approach method. This method satisfies the patch test, however, uses the Lagrange multiplier about twice as much as the two layer model so that it requires a lot of calculations and memory and cannot be easily implemented due to a difficult algorithm.

### SUMMARY OF THE INVENTION

Therefore, the present invention proposes to solve the problems hardly tractable in the finite element method. It is the object of the present invention to provide a method for modeling variable-node finite element meshes capable of improving accuracy of solution and simplifying the implementation when the problem of the non-matching finite element mesh occurs.

FIG. 2 is a schematic concept view of variable-node finite element meshes for solving the non-matching finite meshes. Firstly, the non-matching finite meshes configured of Ω₁ and Ω₂ shown in the left of FIG. 2 can be considered. Since the existing finite element method can consider only a three-node linear triangular element and a four-node linear quadrangular finite element in the case of a two dimensional linear shape function, it is impossible to solve the problem of the non-matching meshes without performing a special process. As a result, the aforementioned methods have been proposed as solutions, however, they have disadvantages of degradation of accuracy and complexity of implementation. In order to easily solve the problems, a variable-node finite element is described in the present application. The most important configuration allows the two elements to share a node where the non-matching boundary surfaces occur. The existing element has a limited number of nodes so that it cannot share a node at the non-matching surface, however, the variable-node element proposed in the present invention may have any number of nodes, making it possible to achieve such a share. Therefore, the matched boundary as shown in the right of FIG. 2 is naturally created. In other words, since such variable-node finite elements transform the non-matching meshes into the matching meshes, it is possible to solve such problems.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 is a concept view of a two layer approach method and a three layer approach method in the prior art.

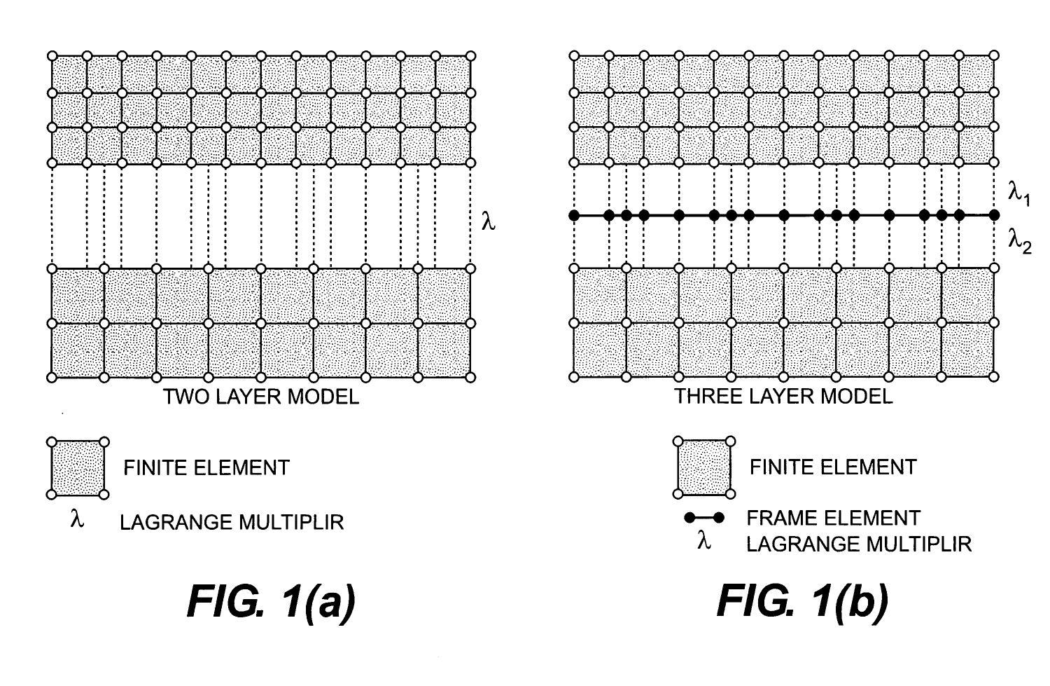

FIG. 2 is a schematic concept view of variable-node finite element meshes according to the present invention.

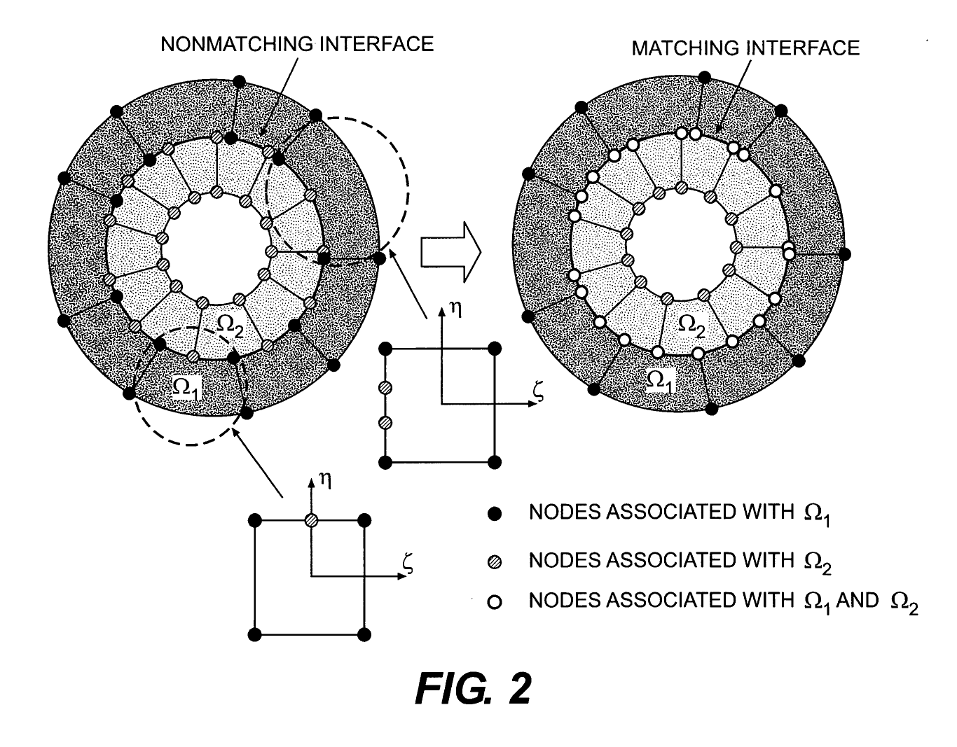

FIG. 3 is a concept view of a method for modeling (4+n)-node (a case of n=3) linear finite element according to the present invention.

FIG. 4 is a concept view of a method for modeling (9+2n)-node (a case of n=1 and 4) linear finite element according to the present invention.

FIG. 5 is a concept view of a method for modeling (5+2n)-node (a case of n=0 and 2) linear finite element according to the present invention.

FIG. 6 is a concept view of a method for modeling (8+2m+2n+mn)-node (a case of n=1 and m=1) linear finite element according to the present invention.

FIG. 7 is a concept view of a method for modeling (8+2m+2n+mn)-node (a case of n=2 and m=3) linear finite element according to the present invention.

FIG. 8 is a concept view of a method for modeling (8+m)-node (a case of n=2 and m=3) linear finite element according to the present invention.

FIG. 9 is a flow chart of a method for modeling variable-node finite element meshes.

### DETAILED DESCRIPTION OF THE INVENTION

The present invention relates to a method and system for modeling finite elements using the finite element method. More specifically, the present invention is to solve the following engineering problems caused by the non-matching meshes via a computer. In other words, a method and recording medium for modeling variable-node finite elements for application to non-matching meshes using the finite element analysis method using the existing four-node linear quadrangular element, eight-node or nine-node secondary quadrangular element, and eight-node hexahedral element, wherein the finite element analysis method includes: a first step of confirming the number of nodes added to boundary surfaces of the non-matching meshes; a second step of dividing the boundary surfaces of the non-matching meshes by means of the added nodes; a third step of dividing the non-matching meshes into partial regions based on the boundary surfaces of the non-matching meshes divided in the second step; a fourth step of forming a shape function by means of the nodes affecting each partial region divided in the third step; and a fifth step of integrating each of the partial regions through numerical integration. Preferably, the numerical integration according to the present invention uses a Gauss numerical integration commonly used in finite element analysis.

As a method of creating the shape function of the variable-node element, a point interpolation using the finite element method is used. With the use of the point interpolation, the value of the shape function in the finite element can be represented by the values at each node by using a defined basis function. This is known to those skilled in the art and the detailed description thereof will therefore be omitted. The variable-node finite elements can be created by using such a shape function. As the two-dimensional problem, there are a (4+n)-node linear element, a two-dimensional (9+2n)-node secondary element, a two-dimensional (5+2n)-node linear-secondary transformation element, a three-dimensional (8+2m+2n+mn)-node linear element, and a (8+n)-node linear element. In all of these cases the basic concepts of the modeling methods are approximately the same.

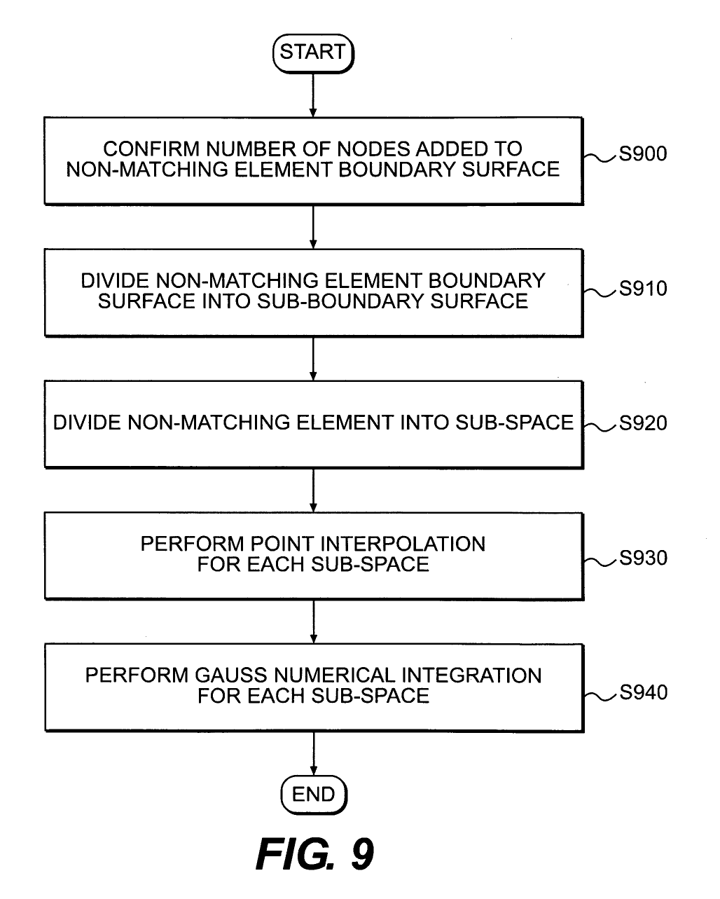

FIG. 9 is a flow chart of a method for modeling variable-node finite element meshes for application to non-matching meshes according to the present invention.

The present invention includes the steps of: confirming nodes added to boundary surfaces of non-matching meshes (S900); dividing the boundary surfaces of the non-matching meshes into partial boundary surfaces (S910); dividing the non-matching element into partial regions on the basis of this; forming a shape function of the affected nodes at each divided partial region (S930); and performing numerical integration for each partial region (S940).

Hereinafter, a concrete modeling method of the present invention will be described with reference to the accompanying drawings.

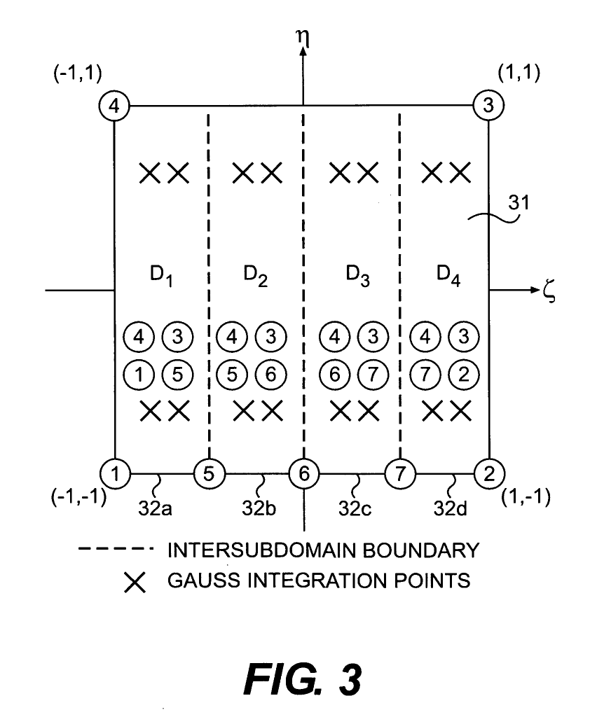

FIG. 3 is a concept view of a method for modeling (4+n)-node (a case of n=3) linear finite element. As a basis function, a fourth order polynomial of [1, x, y, xy] is used. The (4+n)-node element is an element capable of combining one linear element to several linear elements. The boundary surfaces 31 of the non-matching meshes are divided into n+1 partial boundary surfaces 32a, 32b, 32c, and 32d divided by the added nodes and the non-matching meshes are divided into n+1 partial regions D1, D2, D3, and D4 based on the partial boundary surfaces divided in the second step. One finite element is configured of four partial regions and the node participating in the approximation at each partial region is defined by node No. 3, node No. 4 and the two nodes each positioned at the partial boundary surfaces 32a, 32b, 32c, and 32d. The node Nos. used for the point interpolation are indicated in FIG. 3. Therefore, a line segment 43 and line segments 15, 56, 67, 72, and a node interval are indicated by a linear approximation. Each partial region is integrated through a 2×2 Gauss numerical integration.

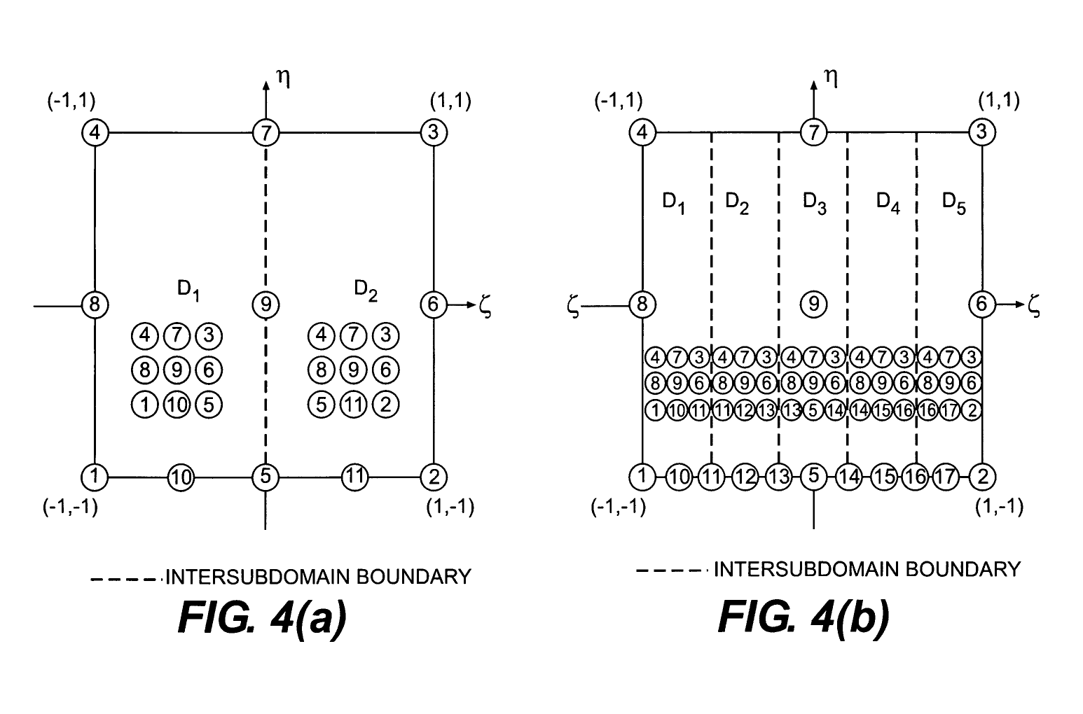

FIG. 4 is a concept view of a method for modeling (9+2n)-node (a case of n=1 and 4) linear finite element. A preferred embodiment of the present invention is a method performed via a computer and analyzing the engineering problems caused by the non-matching meshes. In other words, in the finite element analysis method using the existing nine-node secondary quadrangular element, when the non-matching meshes occurs, the finite element analysis method includes: a first step of confirming the number (2n) of nodes added to boundary surfaces of the non-matching meshes; a second step of dividing the boundary surfaces of the non-matching meshes into n+1 partial boundary surfaces each including three nodes; a third step of dividing the non-matching meshes into n+1 partial regions based on the partial boundary surfaces divided in the second step; a fourth step of forming each of the n+1 partial regions divided in the third step as a shape function based on the remaining six nodes that do not exist at the three nodes of the partial boundary surfaces and at the boundary surfaces of the non-matching meshes; and a fifth step of integrating each of the partial regions through numerical integration.

The (9+2n)-node element, which is an element capable of combining one secondary boundary to several secondary boundaries, approximates each partial region of FIG. 4 to node Nos. 4, 7, 3, 8, 9, 6 and neighboring three nodes as in the (4+n)-node element and uses a ninth order polynomial [1, x, y, xy, x², y, x²y, xy², x²y²] as the basis function. Describing a case of n=4, it has a secondary approximation to (4, 7, 3) and (1, 10, 11), (11, 12, 13), (13, 5, 14), (14, 15, 16), (16, 17, 2). Herein, the (4, 7, 3) signifies the partial boundary surface configured of the node Nos. 4, 7, and 3.

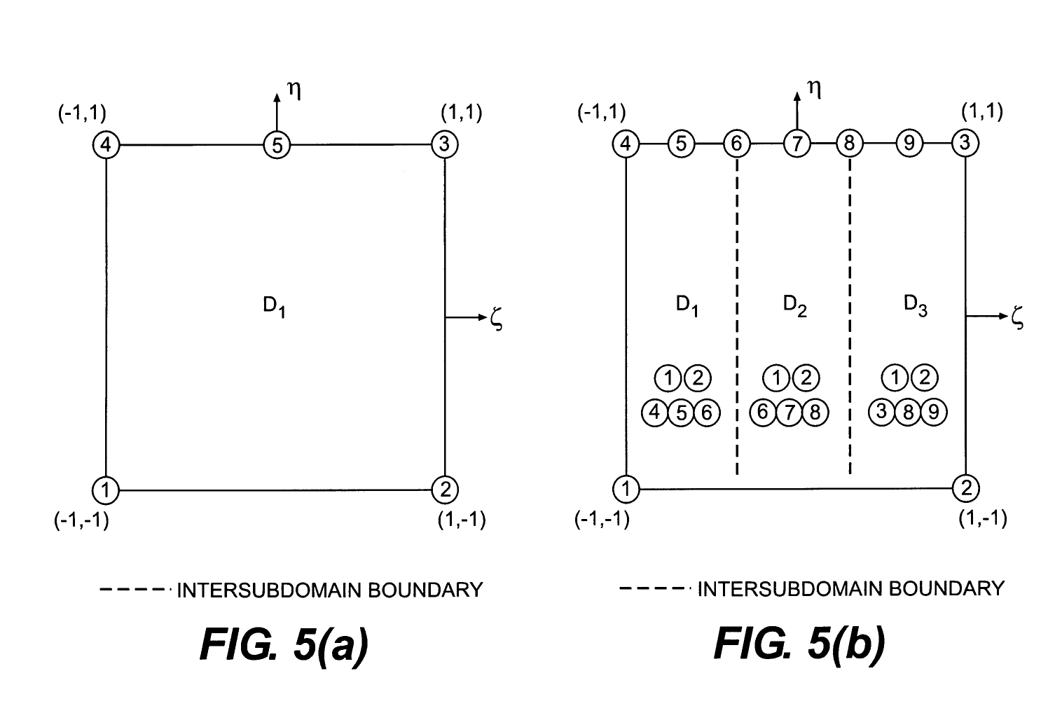

FIG. 5 is a concept view of a method for modeling (5+2n)-node (a case of n=0 and 2) linear finite element. It uses a five order polynomial [1, x, y, xy, x²(1+y)] as the basis function. The preferred embodiment of the present invention may include the following case performed via a computer. In other words, when changing from the element mesh configured of the four-node linear element to the element mesh configured of the eight-node element or the nine-node secondary element, the non-matching meshes occur due to an order difference in the shape function. The configuration of this technology is as follows. The configuration includes: a first step of confirming the number (2n) of nodes added to the boundary surfaces of the non-matching meshes; a second step of dividing the boundary surfaces of the non-matching meshes into n+1 partial boundary surfaces each including three nodes; a third step of dividing the non-matching meshes into n+1 partial regions based on the partial boundary surfaces divided in the second step; a fourth step of forming each of the n+1 partial regions divided in the third step as a shape function based on the remaining two nodes that do not exist at the three nodes of the partial boundary surfaces and at the boundary surfaces of the non-matching meshes; and a fifth step of integrating each of the partial regions through numerical integration.

In a case of n=2, the nodes participating in the approximation to the partial regions are shown in FIG. 5. In order to perform the numerical integration, a 3×2 numerical integration should be performed on each partial region. This is suitable for combining the linear element to any number of secondary elements.

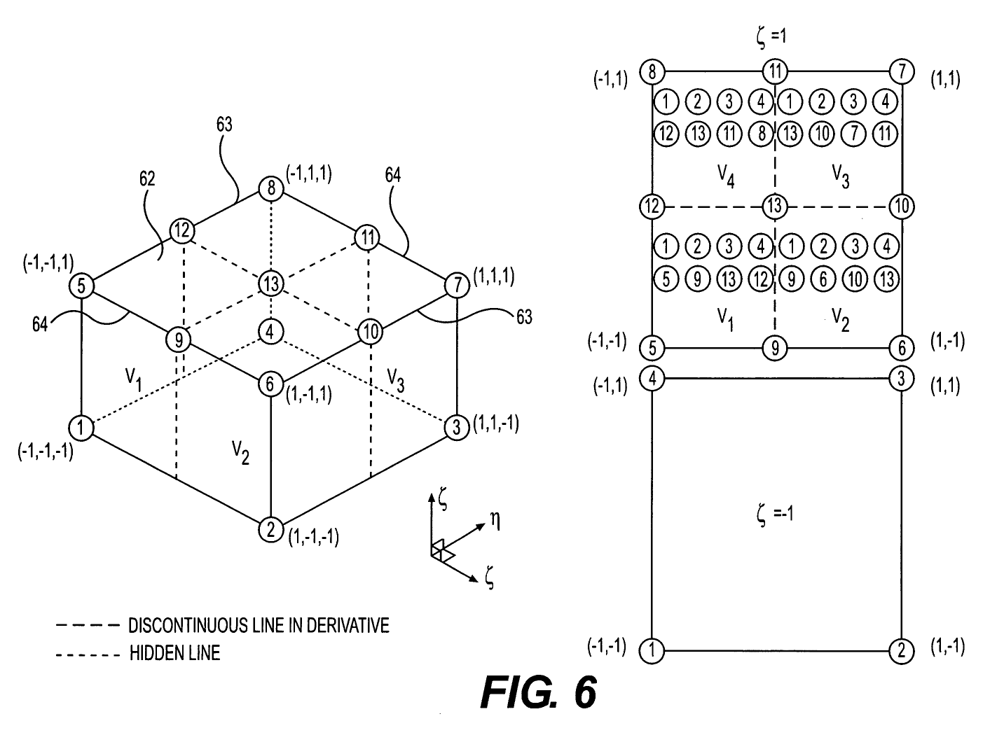

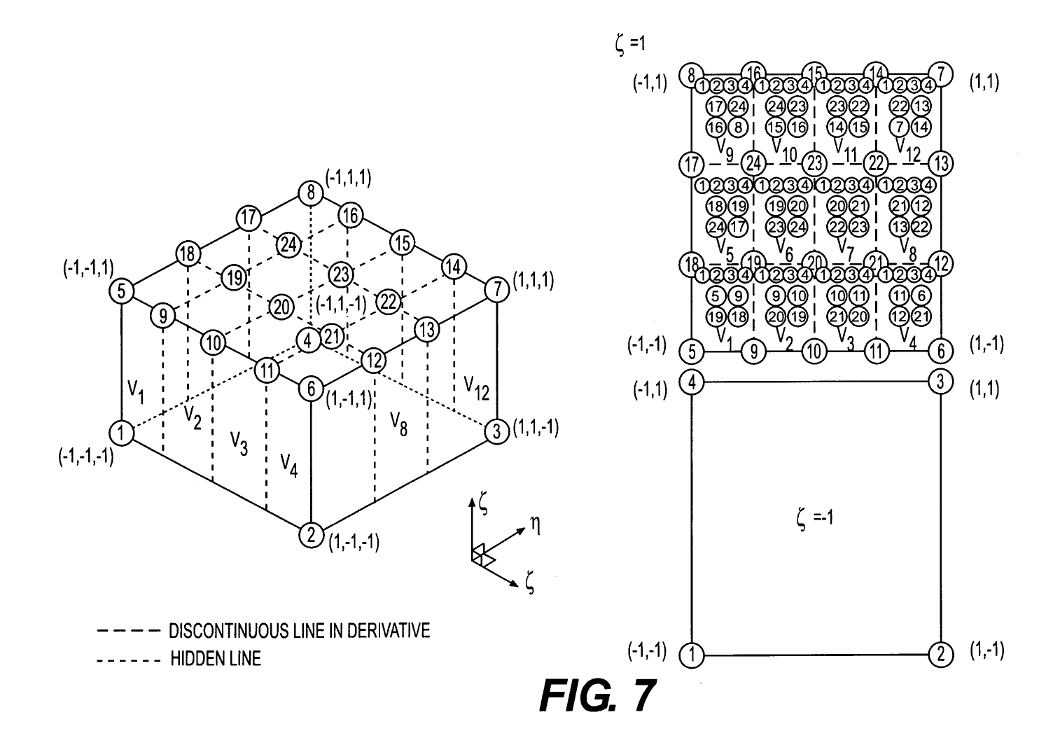

FIG. 6 is a concept view of a method for modeling (8+2m+2n+mn)-node (a case of n=1 and m=1) linear finite element. FIG. 7 is a concept view of a method for modeling (8+2m+2n+mn)-node (a case of n=2 and m=3) linear finite element.

The preferred embodiment of the present invention includes a finite element analysis method performed via a computer and using an eight-node hexahedral element in order to analyze engineering problems caused by non-matching meshes, wherein the finite element analysis method includes: a first step of confirming the number (2m) of nodes added to two horizontal lines 63 of the boundary surfaces 62 of the non-matching meshes, the number (2n) of nodes added to two vertical lines 64, and the number (m×n) of nodes added to the inside; a second step of dividing the boundary surfaces of the non-matching meshes into (m+1)×(n+1) partial boundary surfaces each including four nodes; a third step of dividing the non-matching meshes into (m+1)×(n+1) partial regions based on the partial boundary surfaces divided in the second step; a fourth step of forming each of the (m+1)×(n+1) partial regions divided in the third step as a shape function based on the remaining four nodes that do not exist at the four nodes of the partial boundary surfaces and at the boundary surfaces of the non-matching meshes; and a fifth step of integrating each of the partial regions through numerical integration.

As shown in FIGS. 6 and 7, the nodes participating in the approximation are configured of the node Nos. 1, 2, 3, and 4 and the four neighboring nodes.

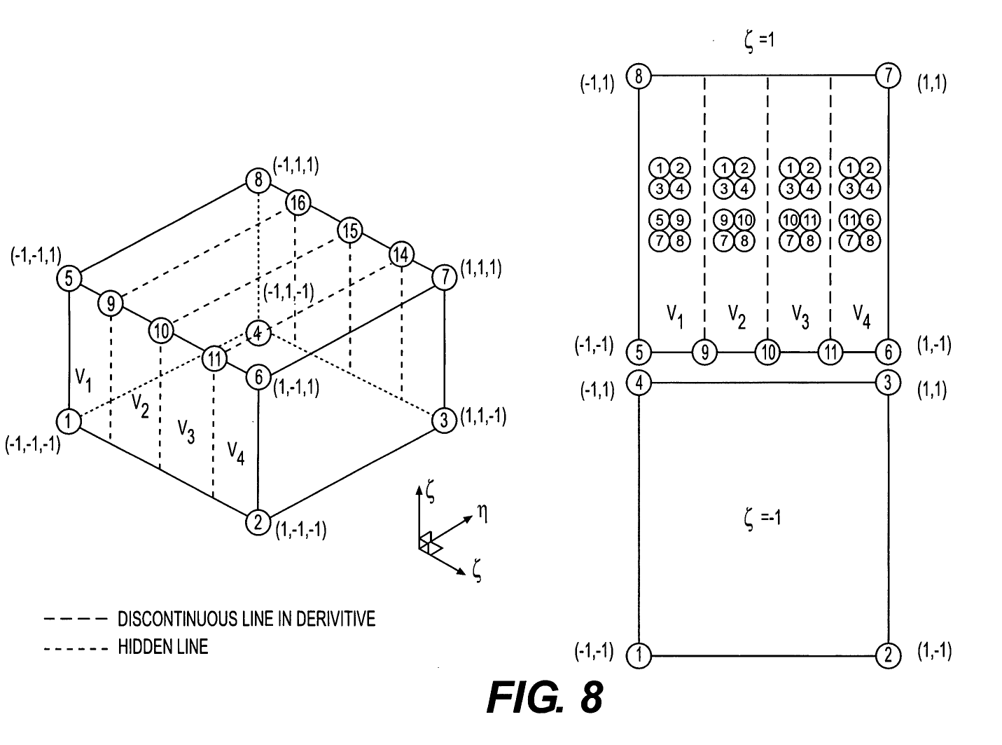

FIG. 8 is a concept view of a method for modeling (8+m)-node (a case of m=3) linear finite element.

The preferred embodiment of the present invention includes a finite element analysis method performed via a computer and using an eight-node hexahedral element in order to analyze engineering problems caused by non-matching meshes, wherein the finite element analysis method includes: a first step of confirming the number (m) of nodes added to one element line of the boundary surfaces of the non-matching meshes; a second step of dividing the one element line of the boundary surfaces of the non-matching meshes into m+1 partial boundary lines divided by means of the added nodes; a third step of dividing the boundary surfaces of the non-matching meshes into m+1 partial boundary surfaces based on the partial boundary surfaces divided in the second step; a fourth step of dividing the non-matching meshes into m+1 partial regions based on the partial boundary surfaces divided in the second step; a fifth step of forming each of the m+1 partial regions divided in the fourth step as a shape function based on the two nodes at the partial boundary lines, the two nodes that exist at the boundary surfaces of the non-matching meshes but do not exist at the element lines and the remaining four nodes that do not exist at the boundary surfaces of the non-matching meshes; and a sixth step of integrating each of the partial regions through numerical integration.

As shown in FIG. 8, the nodes participating in the approximation are configured of the node Nos. 1, 2, 3, and 4 and the four neighboring nodes.

The method for modeling the variable-node finite element meshes have been described up to now. Next, a recording medium of the modeling system recording a program code including the method for modeling the variable-node finite element meshes for application to the non-matching meshes according to the present invention will be described.

A preferred embodiment of the present invention may include a recording medium recording a program executable by a computer performing a finite element analysis method performed via a computer and using variable-node finite elements in order to analyze engineering problems caused by non-matching meshes. More specifically, the finite element analysis method includes: a first step of confirming the number of nodes added to the boundary surfaces of the non-matching meshes; a second step of dividing the boundary surfaces of the non-matching meshes into partial boundary surfaces divided by means of the added nodes; a third step of dividing the non-matching meshes into partial regions based on the partial boundary surfaces divided in the second step; a fourth step of forming a shape function based on the node affecting each partial region in each of the partial regions divided in the third step; and a fifth step of integrating each of the partial regions through Gauss numerical integration.

The recording medium may include a CD-ROM, a DVD, a hard disk, an optical disk, a floppy disk, and a magnetic recording tape, etc. The program code stored in the recording medium to be able to implement the modeling of the finite elements via the computer may be implemented so that the algorithms of the five methods for modeling the five variable-node finite element meshes are the same. This is obvious to those skilled in the art and therefore, the description thereof is not repeated.

The present invention has an effect of providing the modeling method using the variable-node finite element mesh capable of improving the accuracy of solution and simplifying the implementation when the problem of the non-matching finite element mesh occurs.

Although the preferred embodiments of the present invention are described with reference to the accompanying drawings and a numerical analysis, the present invention is not limited to the embodiments and drawings. The scope of the present invention is defined in the accompanying claims. It is to be understood that any improvements, changes and modifications obvious to those skilled in the art are covered by the scope of the present invention.

What is claimed is:

1. A method for modeling variable-node finite elements for application to non-matching meshes using the finite element method performed via a computer and using a four-node quadrangular element for analyzing the engineering problems caused by the non-matching meshes, wherein the finite element analysis method includes:
a first step of confirming the number (n) of nodes added to boundary surfaces of the non-matching meshes;
a second step of dividing the boundary surfaces of the non-matching meshes into n+1 partial boundary surfaces divided by the added nodes;
a third step of dividing the non-matching meshes into n+1 partial regions based on the partial boundary surfaces divided in the second step;
a fourth step of performing a point approximation based on four nodes configuring each of the n+1 partial regions divided in the third step; and
a fifth step of integrating each of the partial regions through numerical integration.

2. A method for modeling variable-node finite elements for application to non-matching meshes using the finite element method performed via a computer and using an eight-node or nine-node secondary quadrangular element in order to analyze engineering problems caused by the non-matching meshes, wherein the finite element analysis method includes:
a first step of confirming the number (2n) of nodes added to boundary surfaces of the non-matching meshes;
a second step of dividing the boundary surfaces of the non-matching meshes into n+1 partial boundary surfaces each including three nodes;
a third step of dividing the non-matching meshes into n+1 partial regions based on the partial boundary surfaces divided in the second step;
a fourth step of forming each of the n+1 partial regions divided in the third step as a shape function based on the remaining six nodes that do not exist at the three nodes of the partial boundary surfaces and at the boundary surfaces of the non-matching meshes; and
a fifth step of integrating each of the partial regions through numerical integration.

3. A method for modeling variable-node finite elements for application to non-matching meshes using the finite element method performed via a computer and using a five-node linear-secondary transformation quadrangular element in order to analyze engineering problems caused by the non-matching meshes, wherein the finite element analysis method includes:
a first step of confirming the number (2n) of nodes added to boundary surfaces of the non-matching meshes;
a second step of dividing the boundary surfaces of the non-matching meshes into n+1 partial boundary surfaces each including three nodes;
a third step of dividing the non-matching meshes into n+1 partial regions based on the partial boundary surfaces divided in the second step;
a fourth step of forming each of the n+1 partial regions divided in the third step as a shape function based on the remaining two nodes that do not exist at the three nodes of the partial boundary surfaces and at the boundary surfaces of the non-matching meshes; and
a fifth step of integrating each of the partial regions through numerical integration.

4. A method for modeling variable-node finite elements for application to non-matching meshes using the finite element method performed via a computer and using an eight-node hexahedral element in order to analyze engineering problems caused by the non-matching meshes, wherein the finite element analysis method includes:
a first step of confirming the number (2m) of nodes added to two horizontal lines of the boundary surfaces of the non-matching meshes, the number (2n) of nodes added to two vertical lines, and the number (m×n) of nodes added to the inside;
a second step of dividing the boundary surfaces of the non-matching meshes into (m+1)×(n+1) partial boundary surfaces each including four nodes;
a third step of dividing the non-matching meshes into (m+1)×(n+1) partial regions based on the partial boundary surfaces divided in the second step;
a fourth step of forming each of the (m+1)×(n+1) partial regions divided in the third step as a shape function based on the remaining four nodes that do not exist at the four nodes of the partial boundary surfaces and at the boundary surfaces of the non-matching meshes; and
a fifth step of integrating each of the partial regions through numerical integration.

5. A method for modeling variable-node finite elements for application to non-matching meshes using the finite element method performed via a computer and using an eight-node hexahedral element in order to analyze engineering problems caused by the non-matching meshes, wherein the finite element analysis method includes:
a first step of confirming the number (m) of nodes added to one element line of the boundary surfaces of the non-matching meshes;
a second step of dividing the one element line of the boundary surfaces of the non-matching meshes into m+1 partial boundary lines divided by means of the added nodes;
a third step of dividing the boundary surfaces of the non-matching meshes into m+1 partial boundary surfaces based on the partial boundary surfaces divided in the second step;
a fourth step of dividing the non-matching meshes into m+1 partial regions based on the partial boundary surfaces divided in the second step;
a fifth step of forming each of the m+1 partial regions divided in the fourth step as a shape function based on the two nodes at the partial boundary lines, the two nodes that exist at the boundary surfaces of the non-matching meshes but do not exist at the element lines and the remaining four nodes that do not exist at the boundary surfaces of the non-matching meshes; and
a sixth step of integrating each of the partial regions through numerical integration.

6. A recording medium recording a program executable by a computer performing the finite element method performed via a computer and using a four-node quadrangular element in order to analyze engineering problems caused by non-matching meshes, wherein the finite element analysis method includes:
a first step of confirming the number (n) of nodes added to the boundary surfaces of the non-matching meshes;
a second step of dividing the boundary surfaces of the non-matching meshes into n+1 partial boundary surfaces divided by means of the added nodes;
a third step of dividing the non-matching meshes into n+1 partial regions based on the partial boundary surfaces divided in the second step;
a fourth step of forming a shape function based on four nodes configuring each of the n+1 partial regions divided in the third step; and
a fifth step of integrating each of the partial regions through numerical integration.

7. A recording medium recording a program executable by a computer performing the finite element analysis method performed via a computer and using a nine-node secondary quadrangular element in order to analyze engineering problems caused by non-matching meshes, wherein the finite element analysis method includes:
a first step of confirming the number (2n) of nodes added to boundary surfaces of the non-matching meshes;
a second step of dividing the boundary surfaces of the non-matching meshes into n+1 partial boundary surfaces each including three nodes;
a third step of dividing the non-matching meshes into n+1 partial regions based on the partial boundary surfaces divided in the second step;
a fourth step of forming each of the n+1 partial regions divided in the third step as a shape function based on the remaining six nodes that do not exist at the three nodes of the partial boundary surfaces and at the boundary surfaces of the non-matching meshes; and
a fifth step of integrating each of the partial regions through numerical integration.

8. A recording medium recording a program executable by a computer performing the finite element method performed via a computer and using a five-node linear-secondary transformation quadrangular element in order to analyze engineering problems caused by non-matching meshes, wherein the finite element analysis method includes:
a first step of confirming the number (2n) of nodes added to boundary surfaces of the non-matching meshes;
a second step of dividing the boundary surfaces of the non-matching meshes into n+1 partial boundary surfaces each including three nodes;
a third step of dividing the non-matching meshes into n+1 partial regions based on the partial boundary surfaces divided in the second step;
a fourth step of forming each of the n+1 partial regions divided in the third step as a shape function based on the remaining two nodes that do not exist at the three nodes of the partial boundary surfaces and at the boundary surfaces of the non-matching meshes; and
a fifth step of integrating each of the partial regions through numerical integration.

9. A recording medium recording a program executable by a computer performing a finite element method performed via a computer and using an eight-node hexahedral element in order to analyze engineering problems caused by non-matching meshes, wherein the finite element analysis method includes:
a first step of confirming the number (2m) of nodes added to two horizontal lines of the boundary surfaces of the non-matching meshes, the number 2n of nodes added to two vertical lines, and the number (m×n) of nodes added to the inside;
a second step of dividing the boundary surfaces of the non-matching meshes into (m+1)×(n+1) partial boundary surfaces each including four nodes;
a third step of dividing the non-matching meshes into (m+1)×(n+1) partial regions based on the partial boundary surfaces divided in the second step;
a fourth step of forming each of the (m+1)×(n+1) partial regions divided in the third step as a shape function based on the remaining four nodes that do not exist at the four nodes of the partial boundary surfaces and at the boundary surfaces of the non-matching meshes; and
a fifth step of integrating each of the partial regions through numerical integration.

10. A recording medium recording a program executable by a computer performing a finite element method performed via a computer and using an eight-node hexahedral element in order to analyze engineering problems caused by non-matching meshes, wherein the finite element analysis method includes:
a first step of confirming the number (m) of nodes added to one element line of the boundary surfaces of the non-matching meshes;
a second step of dividing the one element line of the boundary surfaces of the non-matching meshes into m+1 partial boundary lines divided by means of the added nodes;
a third step of dividing the boundary surfaces of the non-matching meshes into m+1 partial boundary surfaces based on the partial boundary surfaces divided in the second step;
a fourth step of dividing the non-matching meshes into m+1 partial regions based on the partial boundary surfaces divided in the second step;
a fifth step of forming each of the m+1 partial regions divided in the fourth step as a shape function based on the two nodes at the partial boundary lines, the two nodes that exist at the boundary surfaces of the non-matching meshes but do not exist at the element lines and the remaining four nodes that do not exist at the boundary surfaces of the non-matching meshes; and
a sixth step of integrating each of the partial regions through numerical integration.
